(19) United States
(12) Patent Application Publication
(10) Pub. No.: US 2017/0236476 A1
(43) Pub. Date: Aug. 17, 2017

(54) LIQUID CRYSTAL PANEL, LIQUID CRYSTAL DISPLAY, AND PIXEL ARRAY

(71) Applicant: SHENZHEN CHINA STAR OPTOELECTRONICS TECHNOLOGY CO. LTD., Shenzhen, Guangdong (CN)

(72) Inventor: Jiang ZHU, Shenzhen, Guangdong (CN)

(21) Appl. No.: 14/906,391

(22) PCT Filed: Dec. 23, 2015
(86) PCT No.: PCT/CN2015/098425

§ 371 Date: Jan. 20, 2016

(30) Foreign Application Priority Data
Nov. 26, 2015 (CN) 201510836435.4

(51) Int. Cl. G09G 3/36; G02F 1/1362; G09G 3/20

(52) U.S. Cl. CPC G09G 3/3648; G09G 3/2003; G02F 1/136286; G09G 2300/0452; G09G 2310/08; G09G 2320/0242

(57) ABSTRACT

A pixel array for a liquid crystal display (LCD) device is provided. The pixel array has a plurality of pixel units, which constitutes a plurality of even pixel columns and a plurality of odd pixel columns and being respectively connected with the plurality of data lines. While a number N is greater than 2, an Nth data line of the plurality of data lines connects with an Nth pixel row of the plurality of odd pixel columns, and the Nth data line connects with an N−2th pixel row of the plurality of even pixel columns, the number N is an integer, while the number N is less than or equal to 2, the Nth data line is disconnected with any pixel unit of the plurality of even pixel columns. The present invention is used to solve stripes, flickers, and grid issues after applying two pixel rendering (TPR).

### BACKGROUND OF THE INVENTION

Field of Invention

The present invention relates to the field of liquid crystal displays, and more particularly to a pixel array for a liquid crystal display (LCD) device.

Description of Prior Art

LCD have been developed rapidly due to their small sizes, light weights, and low power consumption. However, in order to make the LCD be applied on large screen displaying and to replace the cathode ray tube (CRT) display, the viewing angle characteristic of the LCD should be improved.

The LCD viewing angle problem is resulted from the operating principle of liquid crystal. A liquid crystal molecule is rod-shaped. Different molecule arrangements correspond with different optical anisotropies. The smaller the angle between the incident light and the liquid crystal molecule is, the smaller the bi-refraction is; on the contrary, the larger the angle between the incident light and the liquid crystal molecule is, the greater the bi-refraction is. The angles between light rays entering a liquid crystal cell at different deviation angles from the normal direction of the display screen and the orientation of the liquid crystal molecules are different. As a result, effective optical path differences (OPD) will be different for different viewing angles. The optimum OPD of the liquid crystal cell is designed according to the normal line, which is perpendicular to the liquid crystal cell. For light rays of oblique angular incidence, when the minimum transmittance increases as the angle increases, and the contrast decreases accordingly. A color shift of an image viewed at a large viewing angle is a main drawback of the existing LCD.

In order to reduce the color shift phenomenon, the essence of the multi-domain vertical alignment (MVA) is to improve the color shift phenomenon by forming domains as many as possible. While two different voltages (one high and one low) control different regions of one sub-pixel at the same time, this is an 8-domain improvement technique. While voltages of two levels control two sub-pixels connected with each other, respectively, this is called two pixel rendering (TPR) technique. The TPR technique can achieve a high transparency feature. However, in order to have a finer resolution of the LCD applying the TPR technique, and charge pixel units more fully, special requirements for the arrangement of the LCD pixel units and the inversion manner of the pixel driving voltage are generated.

So there is a need to provide a pixel array used for an LCD device to overcome the problem stated above.

### SUMMARY OF THE INVENTION

An objective of the present invention is to provide a pixel array for a LCD device.

To solve the above problem, the present invention provides a pixel array for an LCD device, comprising a plurality scanning lines and a plurality of data lines. The pixel array comprises a plurality of pixel units.

The plurality of pixel units constitute a plurality of even pixel columns and a plurality of odd pixel columns and being respectively connected with the plurality of data lines. While a number N is greater than 2, an Nth data line of the plurality of data lines connects with an Nth pixel row of the plurality of odd pixel columns, and the Nth data line connects with an N−2th pixel row of the plurality of even pixel columns, the number N is an integer, while the number N is less than or equal to 2, the Nth data line is disconnected with any pixel unit of the plurality of even pixel columns.

In one preferred embodiment, the plurality pixel units comprise a plurality of red pixel units, a plurality of green pixel units, and a plurality of blue pixel units.

In one preferred embodiment, while a residue of dividing the number N by 4 is equal to 0 or 1, the Nth data line receives a first impulse signal; while a residue of dividing the number N by 4 is equal to 2 or 3, the Nth data line receives a second impulse signal.

In one preferred embodiment, the first impulse signal and the second impulse signal are reversed.

To solve the above problem, the present invention provides a liquid crystal panel, comprising a pixel array for the liquid crystal display, comprising a plurality scanning lines and a plurality of data lines. The pixel array comprises a plurality of pixel units.

The plurality of pixel units constitute a plurality of even pixel columns and a plurality of odd pixel columns and being respectively connected with the plurality of data lines. While a number N is greater than 2, an Nth data line of the plurality of data lines connects with an Nth pixel row of the plurality of odd pixel columns, and the Nth data line connects with an N−2 pixel row of the plurality of even pixel columns, the number N is an integer, while the number N is less than or equal to 2, the Nth data line connects is disconnected with any pixel unit of the plurality of even pixel columns.

In one preferred embodiment, the plurality pixel units comprise a plurality of red pixel units, a plurality of green pixel units, and a plurality of blue pixel units.

In one preferred embodiment, while a residue of dividing the number N by 4 is equal to 0 or 1, the Nth data line receives a first impulse signal; while a residue of dividing the number N by 4 is equal to 2 or 3, the Nth data line receives a second impulse signal.

In one preferred embodiment, the first impulse signal and the second impulse signal are reversed.

The differences between the conventional art and the present invention are:

1. The channels of the data driving chip output the voltage with the same polarity in a period of a frame, making the pixel units charge more fully and the liquid display panel save more power;

2. The liquid display panel has a delicate quality and lifelike images after applying the TPR technique;

3. The liquid display panel won't have stripes, flickers, and grid issues after applying the TPR technique.

### BRIEF DESCRIPTION OF THE DRAWINGS

FIG. 1 is a schematic drawing of a pixel array according to the present invention; and

FIG. 2 is a display drawing according to the pixel array of FIG. 1.

### DETAILED DESCRIPTION OF THE PREFERRED EMBODIMENTS

The following description of each embodiment, with reference to the accompanying drawings, is used to exemplify specific embodiments which may be carried out in the present invention. Directional terms mentioned in the present invention, such as “top”, “bottom”, “front”, “back”, “left”, “right”, “inside”, “outside”, “side”, etc., are only used with reference to the orientation of the accompanying drawings. Therefore, the used directional terms are intended to illustrate, but not to limit, the present invention. In the drawings, components having similar structures are denoted by the same numerals.

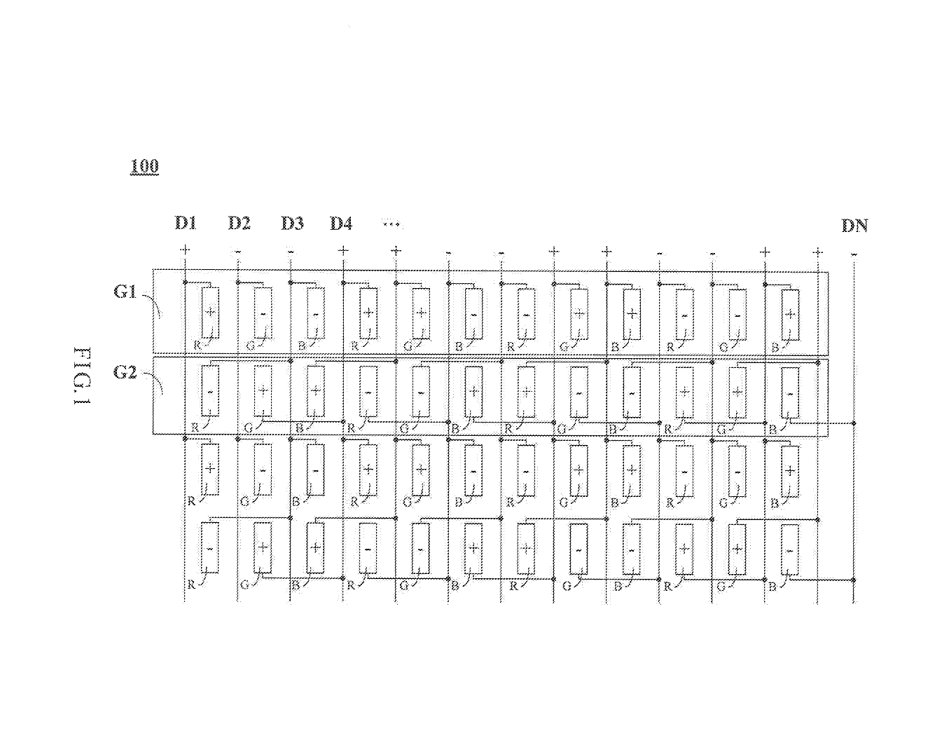

FIG. 1 is a schematic drawing of a pixel array 100 according to the present invention. The present invention provides an LCD device panel which comprises a pixel array 100 for the LCD device. The LCD device comprises a plurality of scanning lines and a plurality of data lines (D1-DN). The pixel array 100 comprises a plurality of pixel units (R, G, and B). The plurality of pixel units (R, G, B) comprise a plurality of red pixel units (R), a plurality of green pixel units (G), and a plurality of blue pixel units (B). The plurality of pixel units (R, G, B) constitute a plurality of even pixel columns G2 and a plurality of odd pixel columns G1. The plurality of pixel units (R, G, and B) respectively connect with the plurality of data lines (D1-DN). Basically, while a number N is greater than 2, an Nth data line DN of the plurality of data lines connects with an Nth pixel row of the plurality of odd pixel columns G1, and the Nth data line DN connects with an N−2 pixel row of the plurality of even pixel columns G2; while the number N is less than or equal to 2, the Nth data line DN is disconnected with any pixel unit of the plurality of even pixel columns G2. The number N is an integer. In the preferred embodiment, while the number N is equal to 1, the first data line N1 connects with a first pixel row of the plurality of odd pixel columns G1, however, because the number N is less than 2, the 1st data line D1 is disconnected with any pixel unit of the plurality of even pixel columns G2; while the number N is equal to 3, the third data line N3 connects with the third pixel row of the plurality of odd pixel columns G1, and the third data line D3 connects with a first pixel row of the plurality of even pixel columns G2. In another preferred embodiment, the plurality of pixel units (R, G, and B) can also additionally comprise white pixel units, and is not limited by the preferred embodiment.

Ideally, while a residue of dividing the number N by 4 is equal to 0 or 1 (such as N1 and N4), the Nth data line DN receives a first impulse signal; while a residue of dividing the number N by 4 is equal to 2 or 3 (such as N2 and N3), the Nth data line receives a second impulse signal. Ideally, the first impulse signal and the second impulse signal are reversed. In the preferred embodiment, the data driving chip applied a “+-+” method to output the first impulse signal and the second impulse signal. In other words, the LCD panel of the present invention applies a “1G1D 1dot crossed pixel” technique, however, the driving method of the present invention is different from a driving method of the main stream.

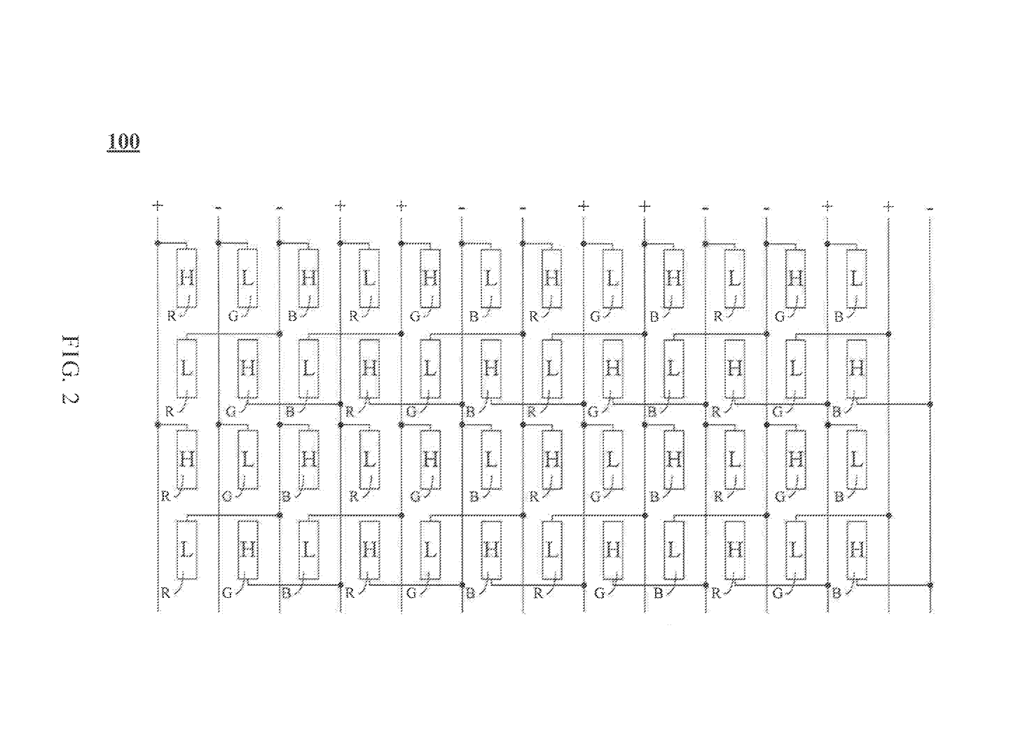

FIG. 2 is a display drawing according to the pixel array 100 of FIG. 1. With the first impulse signal and the second impulse signal which are reversed from each other, every two adjacent pixel units of the plurality of pixel units have reversed light/dark states (for example, four dark pixel units surround one light pixel unit). Because the dark/light pixel units are interlaced, the light pixel units have positive-driving and negative-driving in the same pixel column, to make the LCD panel have more delicate qualities and the pixel units charge more fully.

Although the present invention has been disclosed as preferred embodiments, the foregoing preferred embodiments are not intended to limit the present invention. Those of ordinary skill in the art, without departing from the spirit and scope of the present invention, can make various kinds of modifications and variations to the present invention. Therefore, the scope of the claims of the present invention must be defined.

What is claimed is:

1. A pixel array for a liquid crystal display (LCD) device comprising a plurality scanning lines and a plurality of data lines, the pixel array comprising:
a plurality of pixel units constituting a plurality of even pixel columns and a plurality of odd pixel columns and being respectively connected with the plurality of data lines;
wherein, while a number N is greater than 2, an Nth data line of the plurality of data lines connects with an Nth pixel row of the plurality of odd pixel columns, and the Nth data line connects with an N−2th pixel row of the plurality of even pixel columns, the number N is an integer, while the number N is less than or equal to 2, the Nth data line is disconnected with any pixel unit of the plurality of even pixel columns, every two adjacent pixel units of the plurality of pixel units have opposite bright or dark states.

2. The pixel array for the LCD device according to claim 1, wherein the plurality pixel units comprise a plurality of red pixel units, a plurality of green pixel units, and a plurality of blue pixel units.

3. The pixel array for the LCD device according to claim 1, wherein, while a residue of dividing the number N by 4 is equal to 0 or 1, the Nth data line receives a first impulse signal; while a residue of dividing the number N by 4 is equal to 2 or 3, the Nth data line receives a second impulse signal.

4. The pixel array for the LCD device according to claim 3, wherein the first impulse signal and the second impulse signal are reversed.

5. A pixel array for a LCD device, comprising a plurality scanning lines and a plurality of data lines, the pixel array comprises:
a plurality of pixel units constituting a plurality of even pixel columns and a plurality of odd pixel columns and being respectively connected with the plurality of data lines;
wherein, while a number N is greater than 2, an Nth data line of the plurality of data lines connects with an Nth pixel row of the plurality of odd pixel columns, and the Nth data line connects with an N−2 pixel row of the plurality of even pixel columns, the number N is an integer, while the number N is less than or equal to 2, the Nth data line is disconnected with any pixel unit of the plurality of even pixel columns.

6. The pixel array for the LCD device according to claim 5, wherein the plurality pixel units comprise a plurality of red pixel units, a plurality of green pixel units, and a plurality of blue pixel units.

7. The pixel array for the LCD device according to claim 5, wherein, while a residue of dividing the number N by 4 is equal to 0 or 1, the Nth data line receives a first impulse signal; while a residue of dividing the number N by 4 is equal to 2 or 3, the Nth data line receives a second impulse signal.

8. The pixel array for the LCD device according to claim 7, wherein the first impulse signal and the second impulse signal are reversed.

9. A pixel array for a LCD device, comprising a plurality scanning lines and a plurality of data lines, the pixel array comprises:
a plurality of pixel units, being constituted by a plurality of even pixel columns and a plurality of odd pixel columns and being respectively connected with the plurality of data lines;
wherein, while the number N is larger than 2, an Nth data line of the plurality of data lines connects with an Nth pixel row of the plurality of odd pixel columns, and the Nth data line connects with an N−2 pixel row of the plurality of even pixel columns, the number N is an integer, while the number N is less than or equal to 2, the Nth data line and of the plurality of even pixel columns are disconnected;
while a residue of dividing the number N by 4 is equal to 0 or 1, the Nth data line receives a first impulse signal; while a residue of dividing the number N by 4 is equal to 2 or 3, the Nth data line receives a second impulse signal.

10. The pixel array for the LCD device according to claim 9, wherein the plurality pixel units are constituted by a plurality of red pixel units, a plurality of green pixel units, and a plurality of blue pixel units.

11. The pixel array for the LCD device according to claim 9, wherein the first impulse signal and the second impulse signal are reversed.
